(19) United States
(12) Patent Application Publication
(10) Pub. No.: US 2009/0144039 A1
(43) Pub. Date: Jun. 4, 2009

(54) Optimization of Energy Source Usage in Ships

(75) Inventor: Jon Agust Thorsteinsson, Reykjavik (IS)

Correspondence Address: BIRCH STEWART KOLASCH & BIRCH, PO BOX 747, FALLS CHURCH, VA, 22040-0747, US

(73) Assignee: Marorka EHF, Reykjavik (IS)

(21) Appl. No.: 11/990,302

(22) PCT Filed: Aug. 11, 2006
(86) PCT No.: PCT/IS2006/000016

§ 371 Date: Apr. 7, 2008

(30) Foreign Application Priority Data
Aug. 11, 2005 (IS) 7976

(51) Int. Cl. G06F 17/50

(52) U.S. Cl. 703/6

(57) ABSTRACT

A method, computer program and system for optimizing the usage of energy sources on ships is disclosed. The method involves creating a computer simulation model of a ship, optimized for fuel efficiency. Creating the computer simulation model involves selecting equations from a pool of equations, describing core components and structural features of a ship, and data from a pool of characteristic data for ship's core components and structures. Moreover, a method, computer program, and system for optimizing fuel efficiency of ships by the use of a computer simulation model is disclosed.

### TECHNICAL FIELD

The present invention relates to optimizing the usage of energy sources.

### BACKGROUND ART

The main cost factors in the shipping industry are capital investments and operating costs. Building a ship is an expensive task where core investment decisions are made in the primary design phase and before the project is given to the yard. For example, the total building cost of an 84 meter long processing purse-seiner is in the vicinity of 20 million Euro. On top of this price, the design costs, including primary and final design, are around 5% to 7% of the total cost. These design costs are that low because of solid and durable competition between the consultant companies and can only cover the main engineering design of the vessel. Additional competition is emerging, for example Polish consulting companies are entering the Western European market with lower design prices. The response to this competition up to now has been to increase the standardization of ship designs to make it possible for consultants to sell a project to more than one ship-owner. This reuse of ship design has included the risk of non-optimal solutions for the buyers, and resultant non-optimal operation for the actual fishing operation.

Running cost and maintenance cost are major factors of the total operating cost of a ship. Running costs are principally composed of fuel and lubricants while the major elements of maintenance costs are vessel and gear repair and other expenses such as ship insurance. Maintenance costs can vary substantially from year to year, especially when the maintenance costs arise from the inspection by the insurance companies.

The energy input (fuel) into the power plant onboard a ship is used to produce power for propulsion and electricity production. The usable part of the energy input varies from 38% to 42% while the rest goes to thermal losses such cooling, and exhaust gas losses. A part of the thermal energy is used in some vessels to produce fresh water, and to heat the facilities. In processing vessels, especially shrimp trawlers and dam trawlers, steam is produced by the exhaust gas for the processing deck.

Different power plant systems have been developed for ships like the traditional diesel engine system based on one main diesel engine and auxiliary engines. The main engine delivers mechanical work to both the propeller and to the electrical generator that produces electricity for all electrical users. The propeller is most often a controllable pitch propeller where the propeller thrust can be regulated by the propeller pitch. Other systems have been developed although they are not as commonly used. One of these systems is the diesel electric system where diesel engines mechanically drive electrical generators that produce electrical power for the electrical net. The propeller is a fixed pitch propeller that is driven by a frequency regulated electrical motor and the thrust of the propeller is regulated by the rotation of the propeller. Another system is a diesel hybrid system that is a combination of the two above mentioned systems. In this system, the power plant is similar to the conventional system except that the propeller is connected through a gear to both a diesel engine and an electrical motor. The electrical motor can be started if the main engine falls or to help the main engine drive the propeller.

Until now, extensive work has been done in minimizing the hull resistance and in optimizing the thrust from the propeller as well as optimizing sub-systems and components. However, very limited focus has been applied to the overall onboard energy system design, or to studies of the interaction between the sub-systems and the ship hull and propeller and their utilization of energy.

In recent years, the design and construction time of ships have become shorter and the time from order to delivery from the yard is today typically 15 to 20 months. This relatively short completion time relies on a project being well planned before the yard starts the building work. The pre-design and the engineering design phases are therefore becoming more and more important because currently, once the yard has started on the building work, it is difficult to change the design without delaying the project. As much as 80% of the cost is fixed by decisions made in the primary design phase, while in the engineering design phase, 30% of the cost is fixed and only 10% in the implementation phase. The potential for influencing the cost of a project is therefore greater in the primary design phase when most major decisions are made; there is less scope for reducing costs in the other phases. This applies not only to the shipbuilding industry but also to the chemical industry, where studies indicate that decisions made in the primary design phase account for about 80% of the total cost of a project.

When building a new ship, the most common procedures for the owner is to introduce his project to a consultant company, that works out requirement analyses in close cooperation with the owner. Immediately after the requirement analyses are ready, the company starts work on the engineering design specifically for this owner. Another possibility for the owner is to buy a pre-designed ship from a consultancy firm or a yard and in that way participate in a group of owners who build a series of ships. In comparing these two most common methods, we often see that the pre-designed ship is sold for a lower price because of the opportunity of design reuse by the consultant and the yard. The drawback of the pre-designed ship is that the owner has limited options during the construction of the ship. On the other hand, if the design is specific to the owner, it will be designed exclusively for its intended operation. The negative aspect of the specific design is often the higher investment cost of the ship.

Methods of designing a ship today are most often based on the engineer's lengthy experience and ship design know-how. Methods and designs are reused from time to time and good experience from one project is transferred to another. Also, the likelihood of ending up with an economically feasible design with minimum investment and operation costs, or in total, the lowest net present value cost, is limited. The hardening competition between companies in this industry and the consequently lower prices for vessel design and equipment, along with the overall increase in the size and complexity of the ships, has demanded new and more effective design methods. More reliable methodologies and tools are required that will allow engineers to design more economical ships within a reasonable time and at an acceptable design cost.

Today, ship construction starts with the primary design phase followed by the final design phase and is concluded with the building phase. Little attention is directed to the primary design-phase and for that reason the project jumps from the requirement analyses directly to engineering design.

The fuel consumption of fishing ships operating in the North Atlantic has been increasing significantly over the past decades. There are three main reasons for this. Firstly, oversized energy systems are installed, leading to poor overall energy efficiency. Secondly, fishing gear mass is increasing, and thirdly, onboard energy systems are becoming increasingly complex. Designing a fishing vessel and its onboard energy system is a complicated task with many parameters influencing the design, such as the required speeds for different operations, the type and use of the fishing gear and the onboard power required with reference to variable parameters like the size of catches. When designing a fishing ship, the designers rely on long-term experience and know-how that has been acquired over a long period of time. Ship consultancy firms and shipyards offer increasingly competitive prices, reducing the scope for much needed improvements in the design of more efficient ships. Computer simulation modeling, simulation and optimization are rarely used by designers because of a lack of developed methodologies and design tools.

US2005/0106953A1 Discloses a hybrid propulsion system which includes a main diesel engine for driving the marine turbine and an electric motor. The electric motor has a nominal output that constitutes at least 20% of the nominal output of the main diesel engine. The electric motor remains continuously switched on and maintains, together with a variable-pitch propeller, the main diesel engine at a favorable operating point. The combination of the main diesel engine and the electric motor also allows for a more economical design or operation of the propulsion system.

US2004/0117077A1 Discloses an invention which relates to an electrical system for a ship, comprising generators, electrical consumers, such as electric motors, and an on-board power supply system with switchgears etc. as the components of the system. The electrical system is further characterized in that it supplies sufficient electrical energy in all operating states of the ship and that the system components are automatically controlled by digitized standard modules.

WO96/14241A1 discloses a control device for achieving optimum use of the energy from a vessel's main energy source. The energy is supplied to motors for movement of the vessel in its longitudinal direction, and possibly motors for movement of the vessel in its transverse direction, together with possible motors for the operation of other devices on board the vessel. The device comprises an electrical control network which links the main energy source, the generator device and the motors to a manoeuvring device, a programmable, logic control device, hereinafter called PLS device, and possibly a global positioning system, hereinafter called GP system. The PLS device is arranged to receive information concerning a desired movement of the vessel from, e.g. the manoeuvring device or the GP system and to transmit control impulses to the motors for the operation thereof based on an optimization data programme for achieving the desired movement of the vessel with a minimum energy consumption.

### DISCLOSURE OF THE INVENTION

The present invention (1) presents a new methodology and a new design tool, for the overall design and operation of ships energy system. It seeks to increase the efficiency of ship design by making it possible for designers to use an advanced methodology and employ tools that assist in the design of more viable ships. Using the present invention it is possible to achieve all aspects of the primary design phase (2) and produce designs for economically viable ships (8). Moreover, the design model is further used to optimize (3) the operational cost of the ship in operation by receiving signals from network of sensors (9) and simulating (10) the operation according to the sensor information and adjust (11) the energy system accordingly. Thus the invention (1) has two main parts although the two parts are integral; firstly the design optimization methodology (2), and secondly the operational optimization methodology (3).

In the present invention the term “fuel” refers to any energy carrier such as Fossil fuel, Hydrogen, and so on. Using other energy carriers should not be regarded as a departure from the spirit and scope of the present invention, and all such application of the invention as would be obvious to one skilled in the art are intended to be included within the scope of the following claims.

In one aspect the present invention (1) relates to a method (2) for creating computer simulation model (7) of a ship, optimized for fuel efficiency, said method (2) comprising the steps of: creating a computer simulation model (7) of said ship, based on predetermined constraints (4); optimize (6) said computer simulation model, to obtain an optimized objective function; simulate (6) said computer simulation model (7); analyze said optimized objective function; wherein creating said computer simulation model involves selecting: at least one equation from a pool (13) of equations, the pool comprising: hull core equations; propulsion system core equations; and machinery and structural core equations; and data from a pool of data (13) describing characteristics of ship's core components and structures, and wherein simulating (6) said computer simulation model (7) involves: applying values from said pool of data (13) describing components characteristics to said pool of equations to optimize said fuel efficiency of said ship, and wherein analyzing said optimized objective function involves comparing design parameters of said optimized computer simulation model to said predetermined constraints (4).

In another aspect the present invention relates to a computer program or suite of computer programs so arranged such that when executed on a processor said program of suite of programs cause(s) said processor to perform the method of any of the preceding claims.

In another aspect the present invention relates to a system for creating an optimized computer simulation model (7) of a ship, said system comprising: a human machine interface (5); a computing means; a computer program product; a database (13); wherein an operator creates a computer simulation model of said ship: by communicating design parameters to said human machine interface (5); and optimize said computer simulation model (7) by instructing said computing means to execute said simulation and optimization methods (6) encoded in said computer program, wherein said computing means communicates the resulting model (7) to the operator via the human machine interface (5), and optionally stores said results in memory.

In another aspect the present invention relates to a method for optimizing the building process (8) of a ship for fuel efficiency by use of the above disclosed system.

In another aspect the present invention relates to a method (3) for optimizing fuel efficiency of a ship, said method comprising the steps of: storing a computer simulation model (7, 10) of said ship, said model (7, 10) optimized for fuel efficiency; receiving at least one signal from one or more sensors (9); generating one or more optimized parameters from said computer generated simulation model in dependence on said signals; outputting said parameters to the Human Machine Interface (12) or optionally to the control system (11).

In another aspect the present invention relates to a computer program or suite of computer programs so arranged such that when executed on a processor said program of suite of programs cause(s) said processor to perform the method for optimizing fuel efficiency of a ship.

In another aspect the present invention relates to a computer readable data storage medium storing the computer program or at least one of the suite of computer programs for optimizing fuel efficiency of a ship.

In another aspect the present invention relates to a system for optimizing fuel efficiency of a ship, said system comprising: a processor (15); data storage (14) storing a computer simulation model (7, 10) relating to a ship, said model (7, 10) optimizing fuel efficiency; and a network of sensors (9) for monitoring said ship; wherein said processor (15) is arranged in use to generate one or more optimized parameters from said computer simulation model (7, 10) in dependence on said one or more received signals from said network of sensors (9), and to output said optimized parameters to the Human Machine Interface (12) or optionally to the control system (11).

### BRIEF DESCRIPTION OF DRAWINGS

FIG. 1 shows a block diagram of the main parts of the methodology.

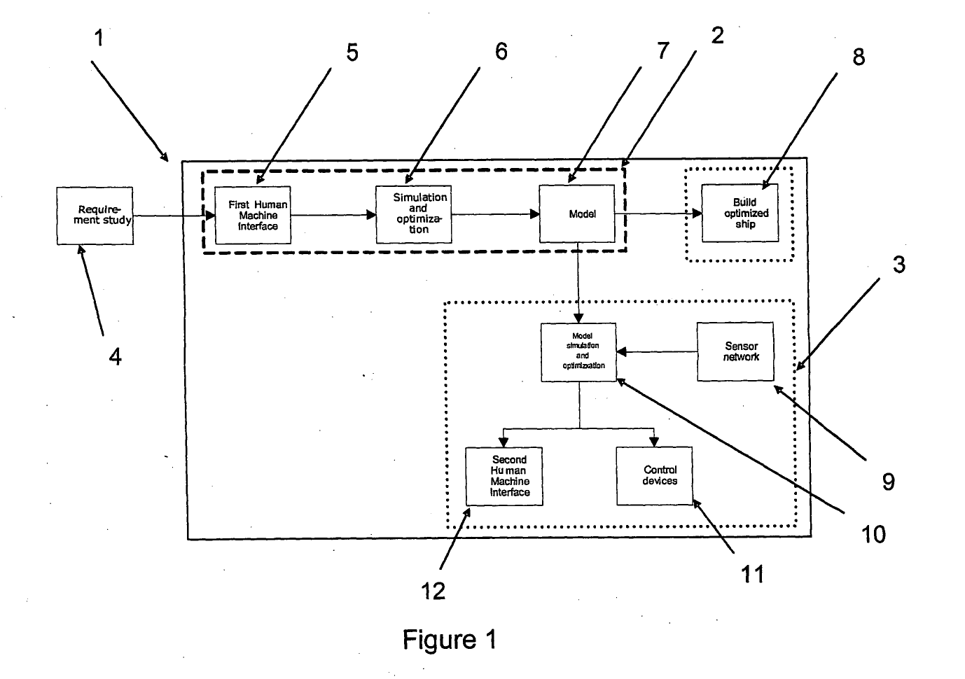

FIG. 2 shows a diagram of the optimized model generation module.

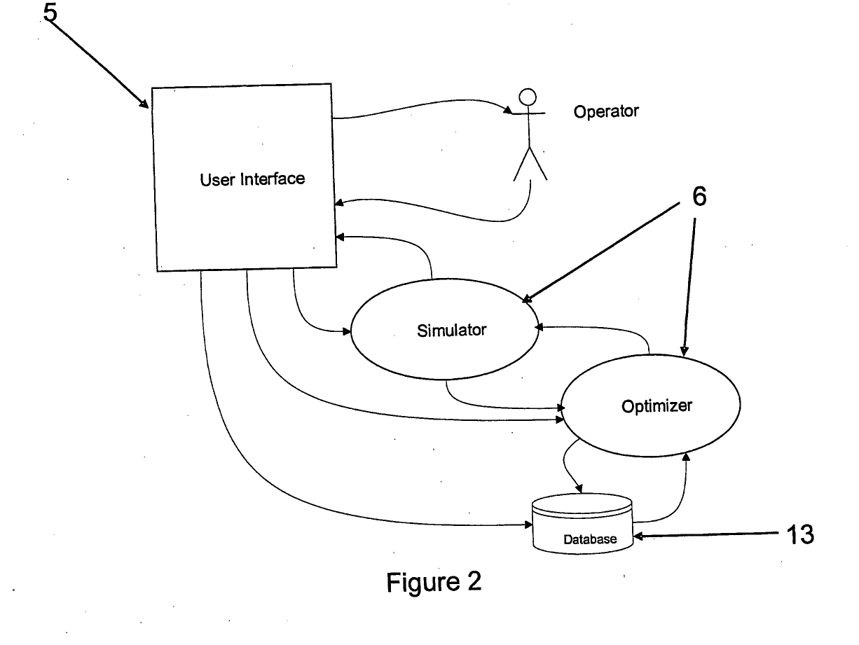

FIG. 3 shows a top level overview of the on board operation optimization system.

FIG. 4 shows a diagram of the operation optimization module.

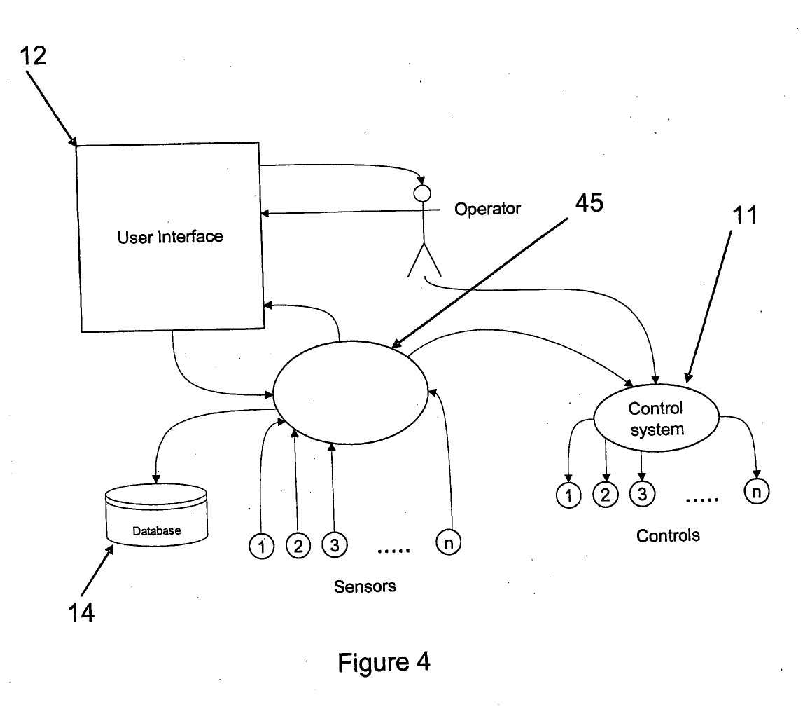

FIG. 5 shows a state diagram of the design optimization algorithm.

FIG. 6 shows a heat exchanger component.

FIG. 7 shows a heat exchanger component model.

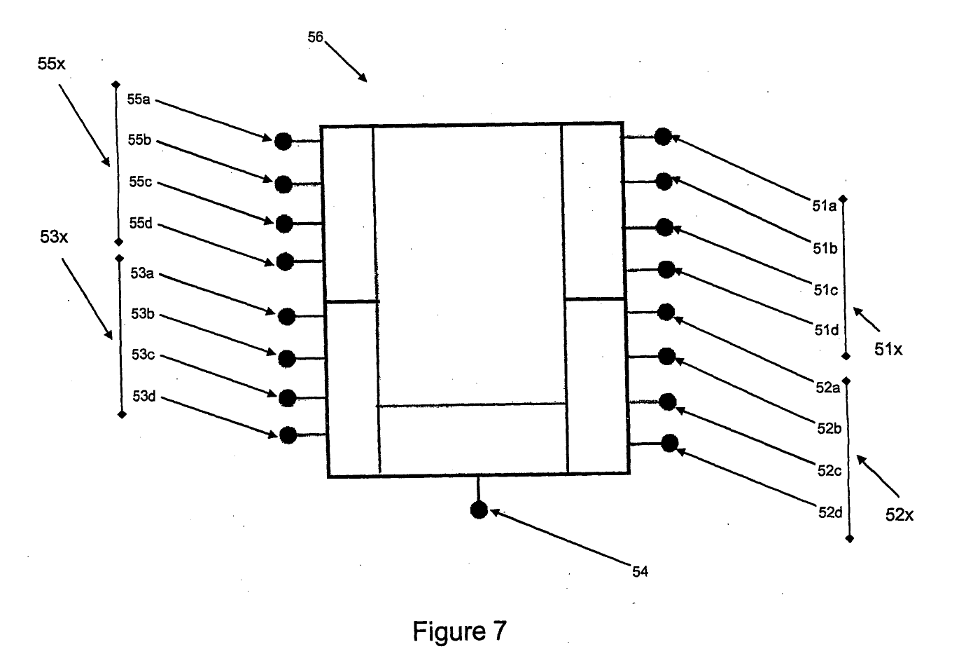

FIG. 8 shows two model components cascaded together.

FIG. 9 shows an example of refrigeration system to be optimized.

FIG. 10 shows a table with optimization results.

FIG. 11 shows graph of operational optimization process using case 1.

FIG. 12 shows graph of operational optimization process using case 2.

FIG. 13 shows a table of the two optimization cases.

FIG. 14 shows a graph of the cooling process for case 1

FIG. 15 shows a diagram of general arrangement and interconnect.

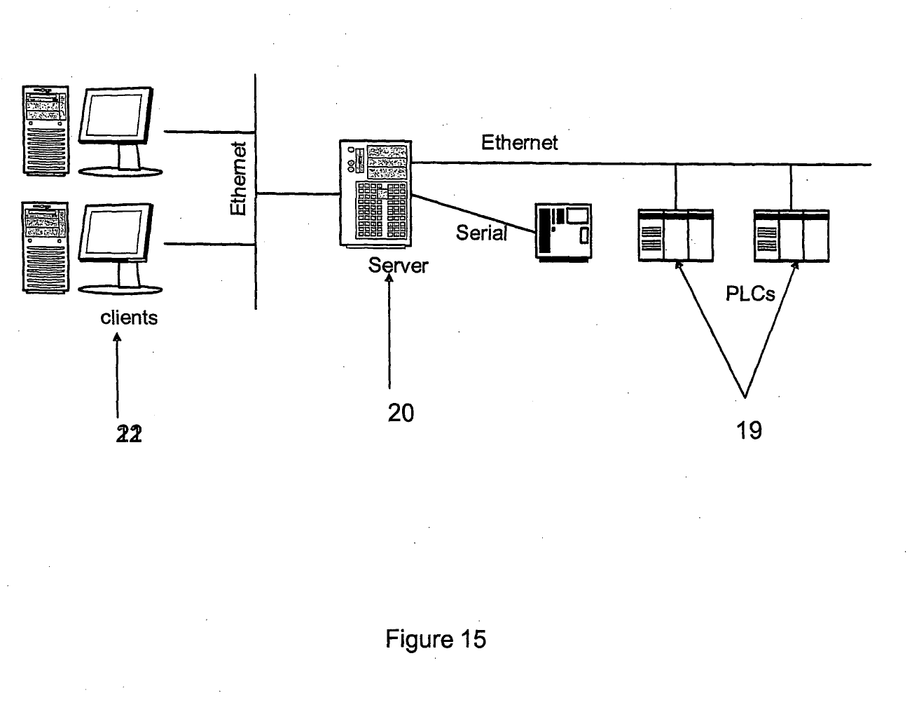

FIG. 16 shows a diagram of the data acquisition.

FIG. 17 shows a diagram of the main functions of the operational optimization module.

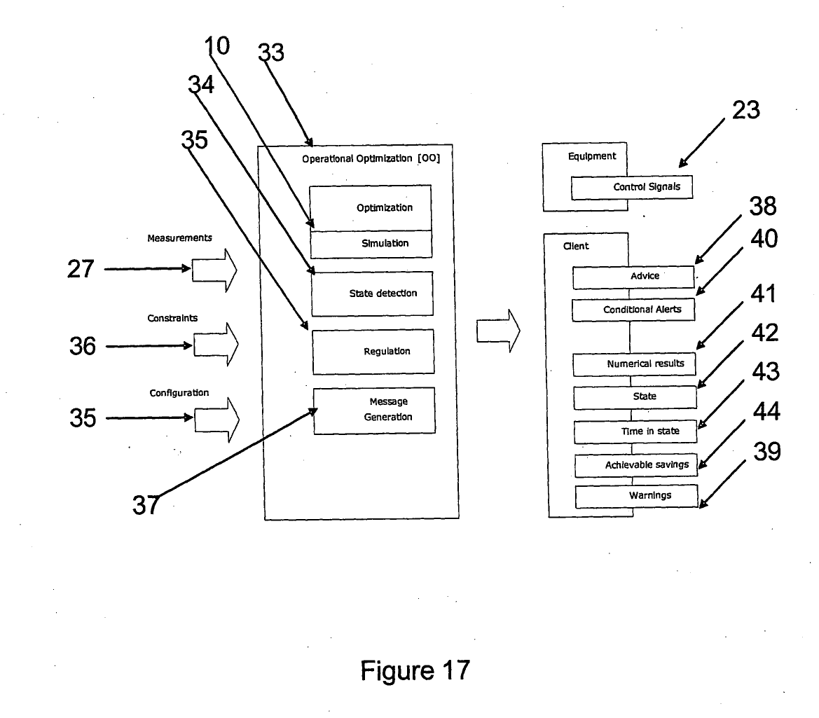

### DETAILED DESCRIPTION

The fuel consumption of a vessel is determined by the coactions of the vessel's machine system, and is affected by external conditions such as weather and currents. Considering that fuel costs are one of the greatest expenses of a vessel, not forgetting the negative environmental effects that fuel consumption has, it is important that it is managed and minimized.

In the present context the following terminology applies:
PLC Programmable Logic Controller
OPC A collection of standards for communications with PLCs and other equipment
OPC Handles communications with one or more PLCs, encapsulating the underlying
Server protocols
OPC Client Connects to 1 or more OPC Servers to read or write values to PLCs
NMEA National Marine Electronics Association communication standard
MetaPower Torque and power measurement system for rotating shafts
Ack Acknowledge (to admit to have recognized)
GPS Global Positioning System
Tag An item being monitored and/or controlled and logged in the system, can be a temperature reading, a pressure value, value derived from other measurements etc.
UI User Interface
GUI Graphical User Interface
HMI Human Machine Interface
deadband a range of allowable change in value
Tooltip A tooltip is a label that displays some text when a mouse cursor on a monitor is positioned over a specific object.
Pdf Portable document format
RAID Redundant Array of independent Disks. A disk subsystem that is used to increase performance or provide fault tolerance.
NA Not Applicable
TCP Transmission Control Protocol. TCP ensures that a message is sent entirely and accurately.
UDP User Datagram Protocol. A protocol within the TCP/IP protocol suite that is used in place of TCP when a reliable delivery is not required.
LAN Local Area Network
ODBC Open DataBase Connectivity. A database programming interface from Microsoft that provides a common language for Windows applications to access databases on a network
Fuel Any energy carrying medium e.g. fossil fuel, hydrogen, i.e.

The implementations of the invention being described in this text can obviously be varied in many ways. Such variations are not to be regarded as a departure from the spirit and scope of the present invention, and all such modifications as would be obvious to one skilled in the art are intended to be included within the scope of the following claims.

The following non-exhaustive listing of equations is intended to provide some insight into the methodology of creating the computer simulation model disclosed above. The core equations listed here are of course not exhaustive listing and the listing is not intended to limit the scope of the present invention. Using other equations obvious to one skilled in the art should not be regarded as a departure from the spirit and scope of the present invention, and all such modifications as would be obvious to one skilled in the art are intended to be included within the scope of the following claims. The set of component equations for describing said ship can be selected from the group of: hull core equations, including equations for calculating: block coefficient; water plane coefficient; mid-ship section coefficient; longitudinal prismatic coefficient; frictional resistance; longitudinal center of buoyancy; appendage resistance; wave resistance; eddy resistance; bow pressure resistance; air resistance; wake velocity; and propeller resistance; propulsion core equations, including equations for calculating: expandable blade area ratio; propeller efficiency; thrust coefficient; and torque coefficient; combustion process; total efficiency; mean pressure; specific fuel consumption; combustion air excess ratio; heat loss through cooling water heat exchanger; heat loss through lubricating oil heat exchanger; and heat transfer to ambient; machinery and structural core equations, including equations for calculating: pressure losses inside heat transfer tubes; pool boiling process; convective boiling process; nucleate boiling process; heat transfer coefficients; flux outside the evaporator tubes; Reynolds number; condensing temperature; Prandtl number; Nusselts number; the above mentioned set of component equations describes the ship according to the requirement study (4) (predetermined requirements).

In the following, the invention will be described in further details with reference to the figures. As discussed earlier, there are two integral parts of the overall methodology as depicted by general scheme (1). Firstly, a method, computer program product, and system for the modeling, and optimization and simulation tool for optimizing the design of a ship for fuel efficiency see partial scheme (2). Secondly, a method, computer program product, and system for optimizing fuel efficiency during operation see partial scheme (3).

The development of simple descriptive models to describe energy systems does not necessarily require systematic modeling methods for the modeler to keep the overview of the code. However, systematic methods are required when developing complicated models for energy systems with hundreds of variables describing the involved components and systems. All components, like pumps, motors and engines, as well as pipes, electrical wires and shafts that connect the various main components must be modeled. Each component can have parameters, differential and algebraic variables and control variables. The parameters are input variables while the differential and algebraic variables (the design variables) are calculated or solved by a solver. During the first phase of the design, the operator must enter the characteristic variables and values of components that will be used for building the ship into the computer. The characteristic values of each component are stored in a database and eventually a library of components is stored up at the computer and the components can be reused over and over again for different simulations.

The simulation of the computer simulation model comprises the steps of:
initializing the control parameters (100), controlling the execution of the algorithm, simulate the computer simulation model by performing the following steps until either an optimal solution is obtained or maximum number of tries have been exceeded:
generate a new test set (101);
temporarily replace old test set with said new test set (102);
count constraints variables (103);
solve said model and calculate objective function(104);
optimize objective function (105);
if an optimal solution is not reached execute the additional steps:
   calculate constraint violations (106);
   calculate optimal value (penalty function) (107);
   and start over from step (101);
store optimized objective function (108);
check if number of iterations are within limit (109);
terminate with optimized computer simulation model (110);
   the resulting optimized and simulated computer simulation model represents an optimal design of the ship according to predetermined requirements and constraints, where the constraints variable comprise limiting factors such as:
   maximum/minimum number of main engines, and specification; maximum/minimum number of auxiliary engines, and specification; maximum/minimum number of propellers, type, and specification; maximum/minimum propeller diameter; maximum/minimum overall length of hull, and design; maximum/minimum number of refrigeration units, type, and specification; maximum/minimum volume of displacement; where multiple constraints variables can be selected at same time for each simulation.

To illustrate the concept lets consider the following example of a heat exchanger and its component model.

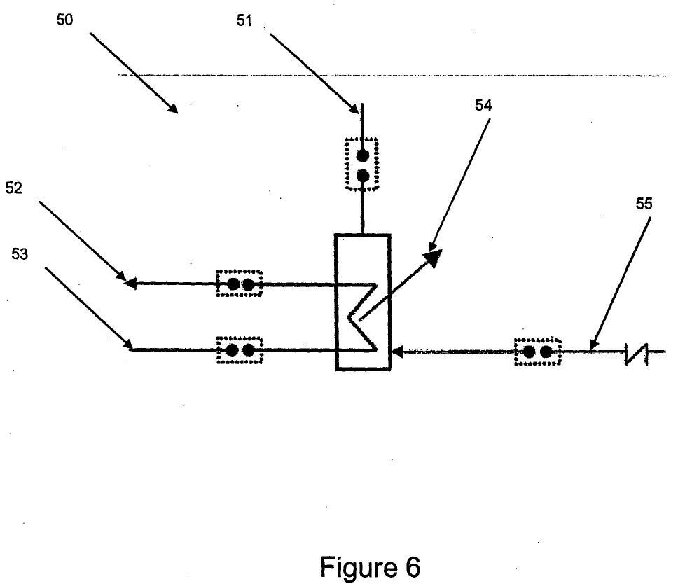

FIG. 6 shows a diagram of an evaporator (50). The evaporator component model is made by assigning connection points. The point where the evaporator is connected to the suction line is labeled point (51). Connection point (55) is the liquid inlet from an expansion valve. Connection point (53) is the water inlet and connection point and (52) is the water outlet. The label (54) represents the heat losses to the surroundings calculated in the component core. These five connection points define the heat transfer associated with the heat exchanger. However, associated with each connection point, except for (54) which represents losses, are four variables: type of fluid, mass-flow, pressure, and enthalpy.

The heat exchanger model component (56) shown in FIG. 6 has therefore, 5 connectors and 17 pins that are to be connected to the model components that provide input to the heat exchanger and subsequent model components that connect to the heat exchanger. The pins (51x) represents the point where the evaporator is connected to the suction fine and the pins (51 a,b,c,d) represents: the type of fluid (heat carrier), mass-flow, pressure, and enthalpy respectively. Similarly, the pins (55x) represents the point where the evaporator is connected to the fluid line after the expansion valve and the pins (55 a,b,c,d) represents: the type of fluid (heat carrier), mass-flow, pressure, and enthalpy respectively. In the same way the cooling water pins (53x) represents the point were the evaporator is connected to the cooling water inlet line, and the pins (53 a,b,c,d) represents: the type of fluid (heat carrier), mass-flow, pressure, and enthalpy respectively. Similarly, the pins (52x) represents the point where the

Fluid₁^{out}=Fluid₁ⁱⁿ

\dot{m}₁ⁱⁿ−\dot{m}₁^{out}=0

Fluid₂^{out}=Fluid₂ⁱⁿ

\dot{m}₂ⁱⁿ−\dot{m}₂^{out}=0

evaporator is connected to the cooling water outlet line and the pins (52 a,b,c,d) represents: the type of fluid (heat carrier), mass-flow, pressure, and enthalpy respectively. Finally, the pin (54) represents the heat losses to the surroundings. Legatos

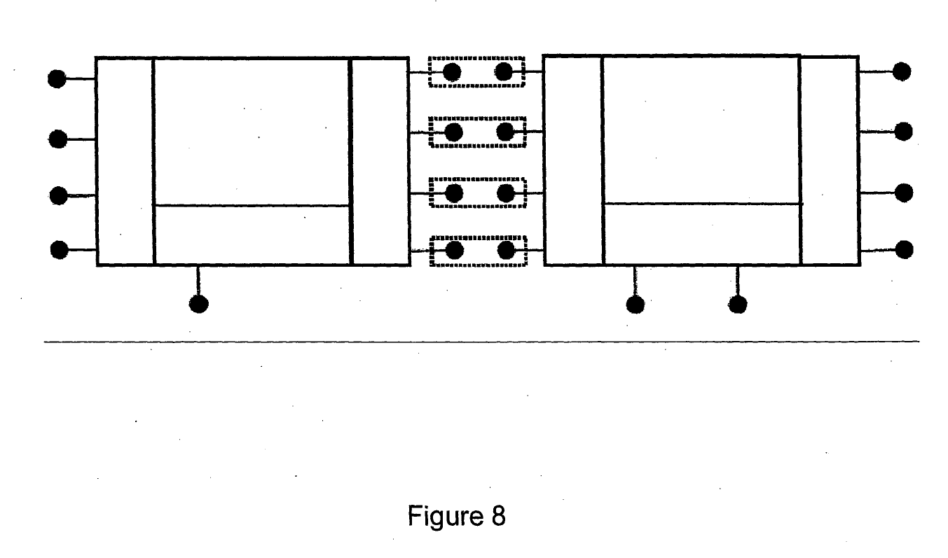

When cascading components together, see FIG. 8, the cascaded component inherits at the inlet the information from the previous component. Inheritance relationship can be illustrated by the following generalized set of equations.

Components, for example for the heat exchanger, can be defined by generalized linear equation describing the type of fluid, momentum, continuity and energy:

$$( {[ \begin{matrix}Fluid \\ P \\ \dot{m} \\ h\end{matrix} ]}_{∀ out} ) = f ( {[ \begin{matrix}Fluid \\ P \\ \dot{m} \\ h\end{matrix} ]}_{∀ in} , Param . , [ \begin{matrix}W \\ \dot{Q}\end{matrix} ] , Contr . var . , Design . var )$$

### Were the:

fluid is the type of fluid,
P is the pressure,
h is the enthalpy,
m is the mass flow,
W is the work,
Q is the heat transfer,
Param. are the parameters,
Contr.var. are the control variables, and
Design.var. are the design variables.

There are eight variables in the four equations above. These eight variables, however, do not completely define a closed system. To close the system, four additional equations are needed that connect the outlet of component II to the inlet of component I. Two more components are needed to connect the system to the outside world, a sink component and a source component. The source and sink components have no variables but include parameters for flow, enthalpy and pressure. The four additional equations needed to connect the system to the outside world are added to the system by connecting the components to sink and source components.

As previously discussed every component (propeller, pump, heat exchangers, etc) is described with a component equation, in addition to the characteristic equations each component has associated with it a cost factor.

When simulating and optimizing a design the operator designing the ship interacts with the Human Machine Interface (5) (HMI) supplying the computer program with the information from the requirement study (4). This would include component equations and component cost factor. After supplying the information the operator executes the simulation and optimization module (6) which in turn creates and delivers the optimized model of the ship (7).

In order to formulate a synthesis problem as an optimization problem, the operator develops a representation of all the alternative designs that are to be considered as candidates for optimal solution. To formulate the possible alternatives, a superstructure optimization methodology is applied. Using this methodology and employing computer simulation technique makes it possible to evaluate a much larger set of possible flowsheets than would normally be covered in conventional process design. The inspiration behind the superstructure is to allow complex connections between all the potential system components and to choose the combination that minimizes or maximizes some objective function.

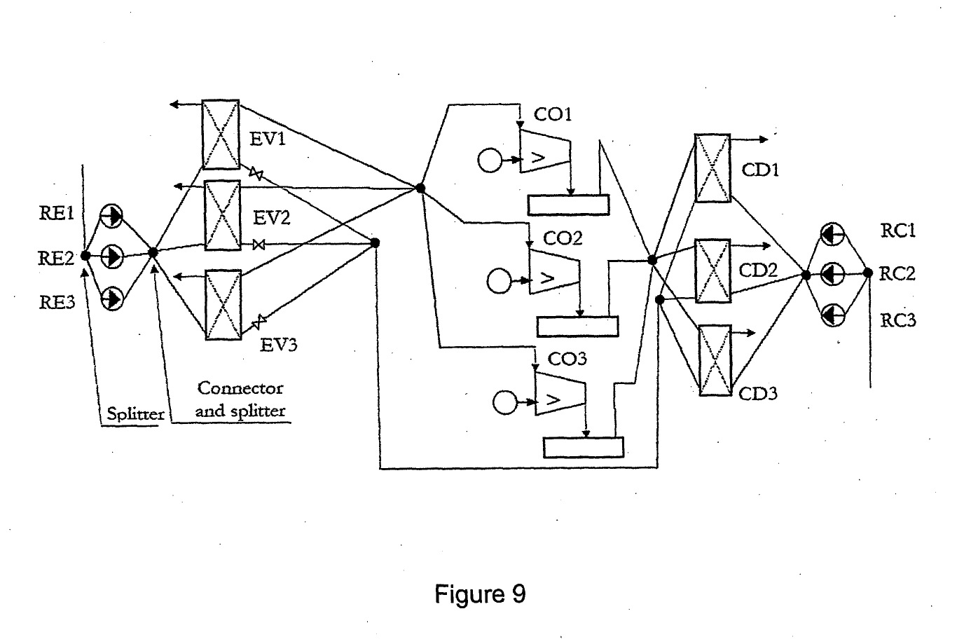

As an example of the present invention, a superstructure of a single stage refrigeration plant is shown in FIG. 9. Each function in the system includes three possible process units (components) in each location. The process unit sets in the system are interconnected by connectors and splitters. The optimized design of the structure is generated by using decision variables, and problem constraints are used to put limitations on the problem. The process unit sets shown in FIG. 9 are, RE for three alternatives of cooling water pumps for evaporator, EV for three different sizes of evaporators, CO for compressors, CD for condensers and RC for three different sizes of cooling water pumps for the condenser. In the optimization one or more of the process units is selected to be included in the refined flowsheet description, depending on the optimization constraints and the object value of the problem.

The following example involves the design of a purse-seiner refrigerated seawater system (RSW system).

Two cases are studied, one with constraints on evaporating temperature at, TE=266° K. and another one with TE=269° K. The system is required to cool 350,000 kg of water from 288° K. to 276° K. within 5 hours. The minimum required refrigeration capacity Q_{E} for this task is around 910 kW.

The maximum velocity inside the heat transfer tubes, v_{tube} is 3.6 m/s and the lowest accepted evaporating temperature T_{E} is 266° K. (case 1) or 269° K. (case 2).

The optimization problem is shown based on a computer simulation model containing performance criteria—the objective function and constraints that the design variables must satisfy. The optimization problem in its generalized the form:

Minimise f(y)

Subject to: gₖ(y) k=0 1, . . . , m

L≦y≦U

where f(y) is the objective function to be optimized, gₖ(y) are the problem constraints and L and U are vectors containing the lower and upper bounds on y respectively. The decision variables, y, are values to be determined using the optimization algorithm. These may be continuous and/or integer variables depending on the problem at hand. An approach to formulate the cost function for components with binary variables is used. In that case, the cost is a constant for each component and the problem is to choose between several different types of component from a superstructure, using the binary variables y_{i,j} indicating whether it is included in the model or not.

The binary variable takes the value 1 if it is included but 0 otherwise. In this formulation, a predefined set of components is defined (superstructure) and several different types of components are selected from the superstructure using the binary variables y_{i,j} indicating whether a component is included in the model or not.

Using this formulation with binary variables, the methodology is used to optimize the refrigeration system shown in FIG. 9, illustrating a superstructure for the RSW system (storage tank not included). The objective is to minimize the total annual operating costs while maintaining the storage tank at the target temperature.

The model of the RSW system is considered as a steady-state mixed integer non-linear (MINLP) model where discrete variables are used to denote which components are included in the design. The non-linear terms come from area calculations for heat exchangers, unit operation performance, thermodynamic properties and energy balances. In this optimization problem, only one connection route is described between two components and used for the possible component's choices.

The optimization problem is set forth as follows: binary variables yᵢⱼ are defined where yᵢⱼ=1 if component of type i is included at location j, but yᵢⱼ=0 if a particular component is not included. In FIG. 9, there are 5 locations (RE, EV, CO, CD, RC), and three choices of equipment in each location. Hence the binary variables are: y₁₁ for the pump on the water side of the evaporator, y₁₂ for the evaporator, y₁₃ for the compressor, y₁₄ for the condenser, y₁₅ for the condenser pump. The objective function f(y) is to minimize the annual cost of power and investment. Wᵢⱼ denotes the power needed for component i at location j, ce is the price of electrical power, t is the annual operating time and Cᵢⱼ is the capital cost of component i in location j, including amortization.

This gives the following objective function:

$$min [ {\sum }_{i = 1}^{{n}_{j}} {\sum }_{j = 1}^{{n}_{l}} {W}_{i , j} {y}_{i , j} ] {tc}_{e} + [ [ {\sum }_{i = 1}^{{n}_{j}} {\sum }_{j = 1}^{{n}_{l}} {C}_{i , j} {y}_{i , j} ] ]$$

where nⱼ is the number of equipment choices in location j, and nᵢ is the number of locations. The maintenance cost is not included in this model. There are two sets of constraints, structural constraints and thermal constraints. Structural constraints are considered first to ensure the correct positioning of various components. The selection of components is controlled by binary variables where only one of each component type can be selected at a particular location.

$${\sum }_{i = 1}^{{n}_{j}} {y}_{i , j} = 1 for j = 1 , … , {n}_{l}$$

The thermal constraints are the second set, giving the following constraints subject to:

Q_{E}≧910 kW

T_{E}=≧266° K. (case 1) and 269° K. (case 2)

V_{EV,tube}≦3,6 m/s

V_{CD,tube}≦3,6 m/s

The master model is formulated based on the initial superstructure including 391 continuous and 15 binary variables. For the simulation, 3 differential and 3 control variables are also included.

The input into the optimizer includes:
Crossover probability p′cε[0,1]
Parent population size μ′ε{1, . . . 100}
Offspring population size λ′ε{1, . . . 100}
Number of generations Gε{10, . . . 500}
Mutation rate p′mε[0,0.5]
Number of crossover points z′ε{1, . . . , 3}

The objective function is the lowest annual running cost for operating the system for 4,000 hours per year, using a capital cost annualized factor of 0.2.

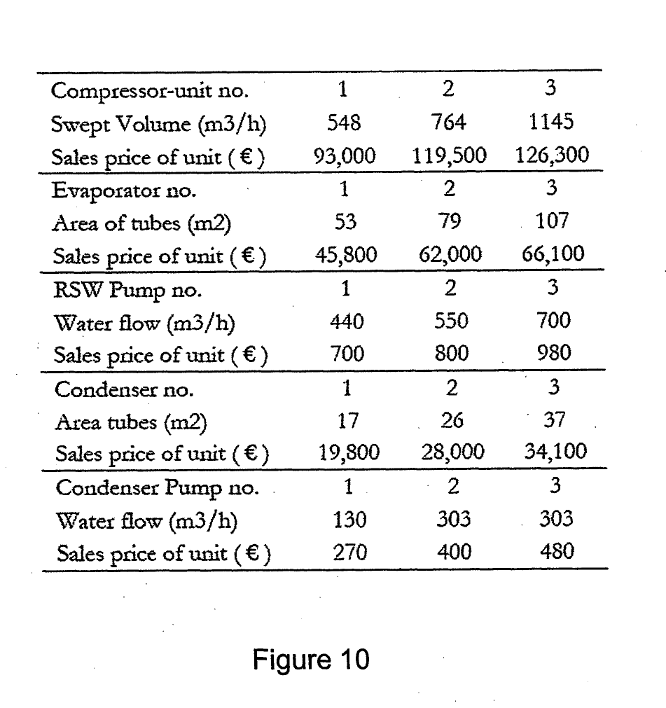

The cost of electricity is based on fuel costs and is assumed to be [symbol] 0.04/kWh. Prices of components and their capacity are given in the table of FIG. 10.

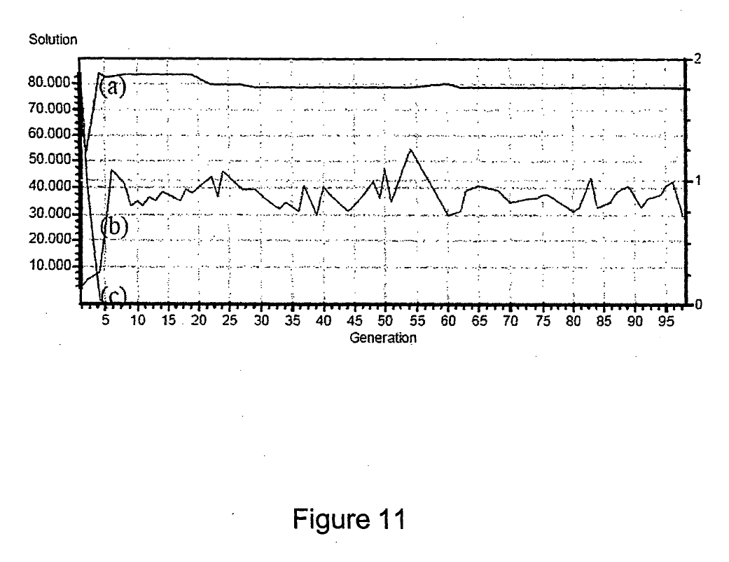

Graph of FIG. 11 shows the results from the optimizer when optimizing for case 1. In this graph, curve (a) indicates the best solution within each generation. The first feasible solution is found at generation 5, i.e. a solution where the structural and internal constraints are not broken. After that, a search for a better solution continues. After 17 more generations (on generation 22) a better solution is found (a solution that has lower cost). At generation 28 an even better solution is found. This is the best solution found in 100 generations. Curve (c) shows the penalty for each solution—notice that the penalty is zero after 8 generations i.e. when the first feasible solution is found. Curve (b) shows the mean penalty function which varies between 2 and 0.

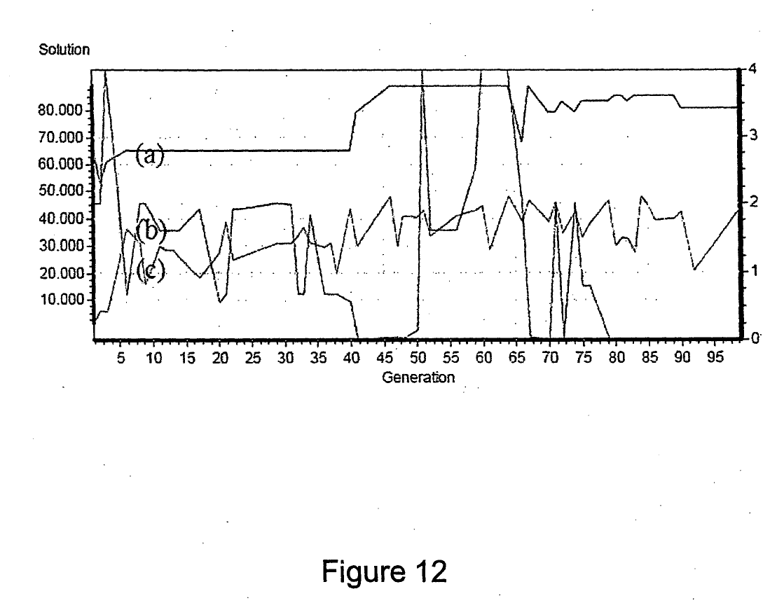

In the second case, see FIG. 12, the constraint on evaporating temperature (TE) is 269 K instead of 266 K as in case 1. Here more generations are required to find a feasible solution because of the increased violation of the constraints on the evaporating temperature. The first feasible solution is generated after 79 generations, see curve (c). In generation 90 a better solution is found (lower cost). In the remaining generations (from 90 to 100) no better solution is generated.

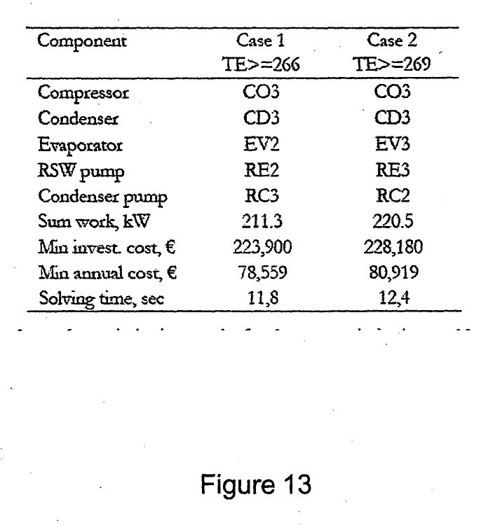

The best solution found is reported in table of FIG. 13. The component selection is shown in the table, and the results from the optimizer show that case 1 has slightly lower annual operating costs than case 2. However, the optimal values are closely comparable.

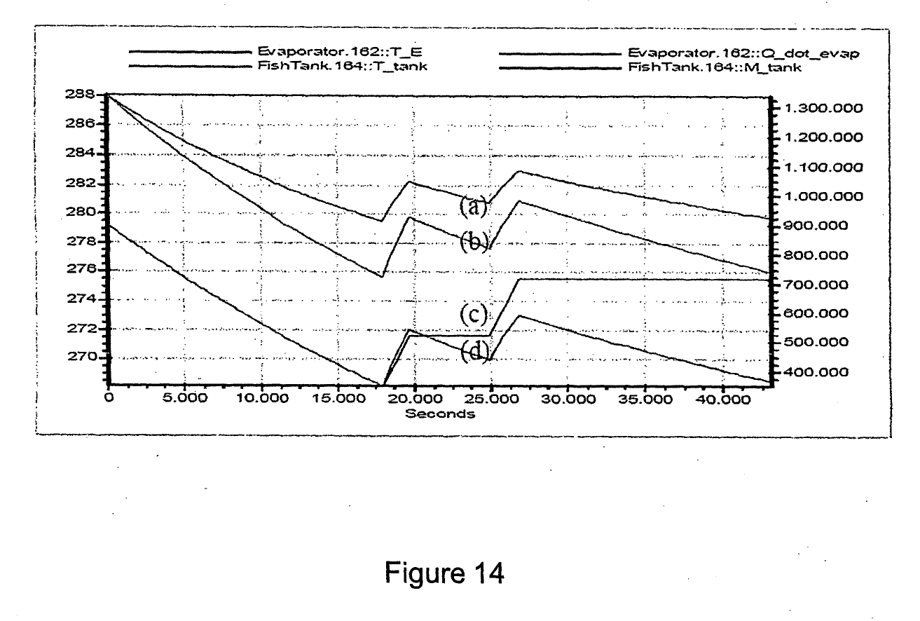

After optimizing the system, the optimal system can be validated by simulation. In this example a simulation is presented for the optimal case, case 1, for illustration purposes. Similar simulation is of course also possible for case 2. In the FIG. 14, the ordinate to the left shows the temperature in Kelvin and the right ordinate shows the refrigeration capacity in Watt and the mass in kilogram. Curve (a) is the refrigeration capacity (W). Curve (b) is the storage tank temperature (K). Curve (c) shows the filling of the storage tank with fish (kg). Curve (d) is the evaporating temperature (K). The simulation starts at storage tank temperature 288 K and the amount of water to be chilled is 350,000 kg. There are three chilling periods (see FIG. 14). The first period (pre-chilling time) is from time 0 seconds to 18,000 seconds. The second period is from time 18,000 seconds (5 hours), to 25,000 seconds. At this point, the tank is filled with fish and cooled. The third period is from time 25,000 seconds to 43,200 seconds and at this point, fish are added to the tank and the target temperature is maintained. While adding the fish to the tank, the refrigeration compressor is stopped and started again at 19,800 seconds (5.5 hours).

The results from the simulation show (FIG. 14, curve b) that at the end of the pre-chilling time (after 18,000 seconds or 5.0 hours), the temperature in the tank has reached 275.8 K. At this time, the evaporating temperature (FIG. 14, curve d) has reached 268.5 K. At time 0 (FIG. 14, curve a), the refrigeration capacity of the system is 1,300 kW caused by the high evaporating temperature and ending just below 910 kW at 18,000 seconds. The amount of water in the beginning is 350,000 kg (FIG. 14, curve c) ending at 710,000 kg of water/fish after two catches have been added to the tank.

The simulation shows that this case (case 1) can meet the design criteria set-up for the system. The lowest evaporating temperature in the system when running, period 1 (cooling) and period 2 (adding fish to the tank) is 268.5 K where the system is able to chill the storage water within five hours (18,000 sec). The annual operating cost of this case is [symbol] 78,559 (see table of FIG. 13) while the total investment is [symbol] 223,900.

The above examples and illustrations show the methodology and operation of the present invention for a given sub problem. When designing large scale energy systems such as in ships, each sub system to be considered is modeled. Each component of each subsystem has associated with it some equations and/or parameters. Most often there are three different families of equations, a component core equations, component connection equations, and component cost equations.

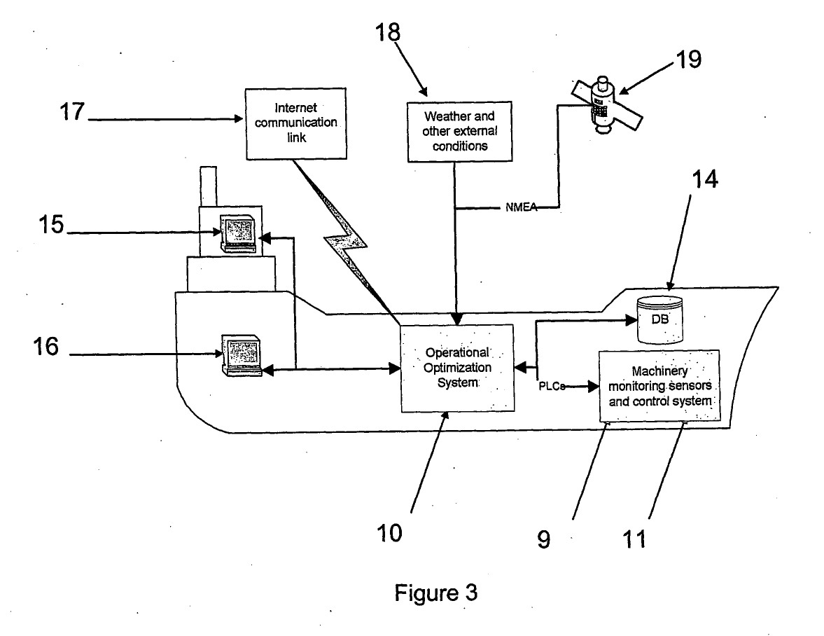

The perspective of the operational optimizing system (3) is seen in FIG. 3. The system (3) is connected with the vessel's machine systems (9) through programmable logic controllers (PLC), as well as equipment that measure various external conditions (18) and equipment that provides global positioning information. Real-time data is stored in a central database (14). Real-time and historical information about the state of the vessel's systems is provided, both to the control room (12a) and to the bridge (12b). To manage energy consumption, the system (3) is both able to recommend fuel saving procedures to the user, and automatically control (11) the machine systems according to operational optimization algorithms and user settings. Moreover, the system provides a web interface, to enable users to access specific web-systems.

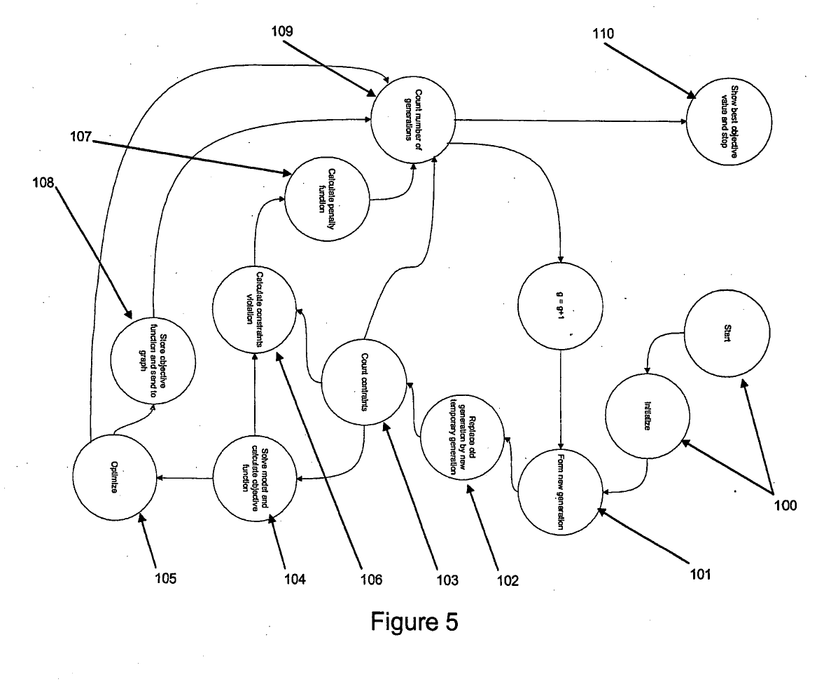

The general scenario for the system installation is seen in FIG. 5. PLCs (19) are responsible for acquiring measurements and controlling controlled objects where applicable. A server computer (20) is responsible for managing and evaluating all data (real-time and historical), for automatic control, and for delivery of automatic and manual control messages to PLCs (19) where applicable.

The client computers (12) present data (real-time and historical) to the operator, provide for manual control where applicable, and allow for configuration of the system. Multiple clients can run at the same time, and the server can also run the client software.

The operator interacts with the system through the client computer (12) using for example a pointing device such as a mouse and keyboard as inputs, and monitor for output. Information about the status of a vessel's machine systems is collected from OPC servers using the OPC protocol. Conversely, the system delivers control parameters to controlled objects of these systems through OPC interface. Some information, e.g., GPS and MetaPower, is collected using the NMEA protocol. TCP is used in all communications over LAN, except when the Maren Server talks to the NMEA devices over LAN, in which case UDP is used.

The system functionality is divided into two primary functions. These are: Client functions, and Server functions.

### Client:

The client can support two configurations: One for the control room (engineers) and the other for the bridge (captains). The difference lies in the number of UI-components that shall be available to the user through the Navigation pane, and the size of UI-elements.

As previously stated, the operator interacts with the system through a client computer using a monitor, pointing device such as mouse and keyboard. The user interface shall have the following panes available at all times.

A Logo and Date/time is displayed as well as the current system date and time according to the Universal Time.

A Navigation pane allows the user to navigate between the different User interface (UI) components.

A Message pane displays time-stamped messages and possible recommended operations. The Message pane provides means to acknowledge messages (changing their status from “Pending” to “Acknowledged”). “Acknowledged” messages and “Invalidated” messages are automatically removed from the Message Pane, but are available from history. If the message contains a recommended operation, the user should be able to approve the operation from the Message pane, changing its status from “Pending” to “Approved”. Messages should be listed in chronological order, meaning that the newest valid message is listed first.

A System pane displays an interface to the currently chosen UI-component. A UI-component can have its contents divided into at least one page/screen. If the content is divided between two or more pages/screens, the UI-component provides a list of the names of these, which are displayed in a special section of the System pane. The System pane has a titled window to page contents. One page is chosen and visible at each time. If a UI-component has only one page, that is its default page. UI-component's default page is opened when the UI-component is chosen from the Navigation pane.

Trip Information pane displays general information about the current trip, such as its duration, oil usage and costs. For fishing vessels, the duration of ongoing trawling is displayed (trawling clock) and the duration of last trawling is displayed in between different trawling.

The following UI components are available to be displayed in the system pane.

Tag Settings displays the currently defined system tags and detailed information about the currently chosen tag.

Human Machine Interface (HMI) lists system diagrams and other figures currently defined in the system. It shows the currently chosen system diagram or figure. System diagrams are models of the vessel's systems and show the current state of the vessel. Other figures show for example the deviation from optimal operation.

History Viewer charts a historical overview of measurements and derived values. The History Viewer should list the currently defined tags in the system, and names of line charts that have been created and saved for quick retrieval of frequently viewed data. The History Viewer should show the currently chosen line chart. Each line chart is derived from values of one system tag or a set of system tags.

Report Viewer lists all report types that are generated in the system. When a report type is chosen from the list, a report of that type is generated according to up-to-date information. Trip Summary shows information about present and past trips, and allows for editing of certain trip properties. The type of information displayed depends on the application area (e.g. fishing vessels or cargo carriers).

Web interface is provided and allows the user to access predefined 3^{rd} party web systems (e.g. web-based email client). It should NOT provide complete Internet access. Zero, one or more such web interfaces should be provided and shown as different items in the Navigation pane. Message History shows a chronological list of messages that have been generated in the system and sent to users (to the Message pane), along with their status (“Pending”, “Acknowledge”, “Approved”, “Invalid”).

Suppliers' Diagram Library lists all System/Pipe diagrams that are available from the suppliers of the vessel's machine systems. The user should be able to browse between diagrams and zoom in and out of diagrams.

System Monitor displays the status of system services.

Cruise control assists the operators in controlling the ship when it is steaming. The cruise control UI-component enables the operators to modify the cruise control configuration and constraints and view its status. Different cruising strategies can also be compared. Help User help should be provided in the form of a user manual in portable document format (pdf), enabling browsing between different topics.

### Server:

The server primarily handles the Data Acquisition, Storing and Delivery, Operational Optimization, Message Generation and Delivery, Report generation.

### Data Acquisition:

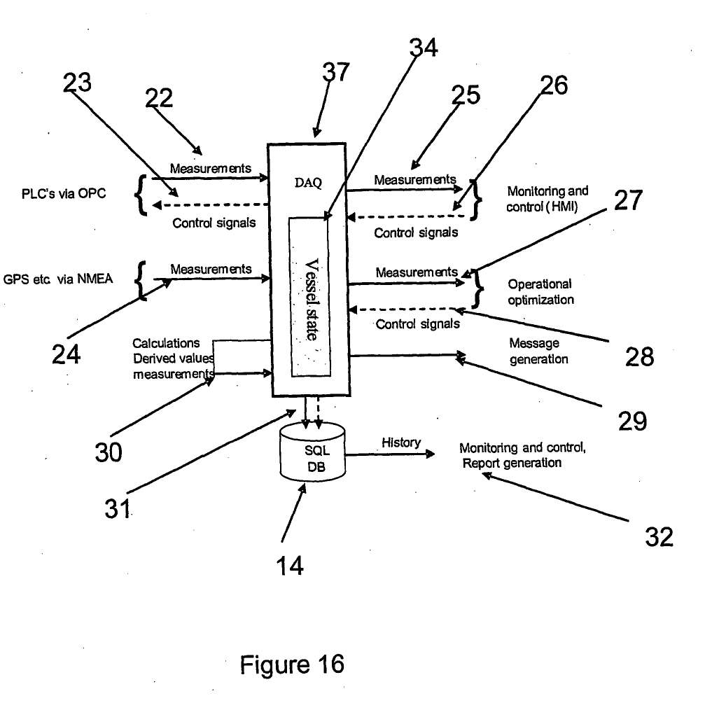

The Data Acquisition [DAQ] (37) is shown in FIG. 16. It receives measurements (22) from PLC's monitoring different items of the machinery and delivers control signals (23) to the control devices. It, moreover, receives measurements and information (24) from external sources such as GPS and weather monitoring instruments. The DAQ (37) also delivers messages (25) to the client computers, and receives control signals (26) also from the client computers. The operational optimization module also receives measurement signals (27) from the DAQ (37) and delivers control signals (28) to the DAQ (37). The DAQ (37) also generates messages (29) based on the measured values. The DAQ (37) also derives (30) new values or tags from received measurements. Finally, periodically the DAQ (37) loggs (stores)(31) values in the database for historical retrieval, and monitoring and control generation(32). The logging interval is configurable, but the default is 15 sec.

The DAQ (37) is an OPC client, and connects to one or more OPC servers. In accordance with the OPC specification, OPC server tag groups, containing OPC Items, are created for each server connection with a specific update rate (and possibly deadband). Each OPC Item is mapped to a specific tag, e.g. “Omron-HostLink.C500.DM0015” might correspond to “Tension to starboard trawl winch”. The OPC server delivers to the DAQ (37) updated values for tags in a tag group, at the interval specified for the tag group (e.g. every 500 ms), only for values that have changed more than specified by the tag group's deadband (e.g. 2%).

### Tags:

An NMEA tag is mapped to a specific NMEA string and a field number. Example:

The tag “Speed [knots]” is mapped to the NMEA string identifier VTG, and field number 7. If the DAQ receives the following NMEA string: $GPVTG,89.68,T,,M,0.00,N,0.0,K*5F The value of the tag “Speed [knots]” is set to 0.0 knots (7^{th} field).

Derived tags are tags calculated from other tags. They can be calculated from measured tags or other derived tags. The derived tags are calculated and sent whenever some parameter tag is modified. Tags that are calculated from time dependent functions such as the running average shall also be updated periodically.

The DAQ shall connect to the operational optimization service and receive model tags. Model tags contain the value of variables that are defined in the simulation model and are updated after its solution. The input parameters used in the simulation model are the measured parameters, i.e. not the optimal parameters.

Timer tags are associated with another tag and some condition(s). Timer tags measure time, and tick while the condition is fulfilled. They can be used to monitor running times, e.g. “Running time of main engine” with the condition “Engine RPM”>100.

### Operational Optimization and Message Delivery:

The Operational Optimization System (OO) (33) receives measurements (27) from DAQ of the state of equipment onboard the vessel and uses that information to increase its fuel efficiency. To achieve this, the system uses a computer simulation model (7) of the vessel to find optimal values of the ship's operational parameters. The optimal operational parameters are then either used to control (23) onboard equipment or to generate advice (38) to the ship's operators on how its energy efficiency can be increased.

The general objective of the system is to generate control signals (23) and advice (38) such that if the advice is followed the deviation between simulated values and measured values will be within a predefined tolerance after a fixed time interval, and that the simulated values are near optimal.

It is also possible to specify a condition that a specific measured variable (tag) shall fulfill and have the OO system generate a warning if the condition is broken (max, min conditions). Conditional warnings (40) are defined by the ship's operators via the client computers (Tag Settings). The OO receives the latest measurements from DAQ (27). System configuration and constraints are read from the database (14) but can in some cases be configured by the ships operators once the system is started. Constraints and configurations that can be modified are identified as such in the database and all changes to them shall be logged.

The system configuration (35) determines which variables are to be controlled by the system. The configuration (35) is loaded from the database (14) when the system is started and it can also be modified once the system is running, for example when turning on cruise control which requires the system to take control of the propeller thrust.

The constraints (36) are conditions that the system should try to full-fill when controlling equipment. They are loaded when the system is started and can be modified once it is running. The operators can for example specify time constraints for the cruise control.

The main units of the OO system are:

### Optimization:

The optimization unit (10) uses various optimization algorithms to find optimal values of operational parameters. The OO system includes optimization algorithms that can be used to efficiently optimize the control of, e.g., refrigeration systems, propulsion systems and fishing gear. The optimization problem can be a linear or nonlinear problem of multiple variables that uses a simulation module (7) to calculate its objective function. It shall also be possible to integrate optimization algorithms in external libraries into the system.

The simulation module (7) that describes the system is an external library created specifically for each installation.

### State Detection:

The state detection unit (34) monitors measurements of the state of equipment and attempts to identify the operation being performed onboard. The possible states differ between vessels, for fishing vessels, e.g., the possible states could be: “trawling”, “pay out”, “hauling”, “steaming”, “preparing”, and “pumping”.

### Regulation:

The regulation unit (35) is used to regulate controlled values that are not optimized because of constraints that apply to them. For example, in the cruise control, the operators can specify that the ship should be steeming at a constant speed which requires that the propeller thrust is regulated in order to maintain that speed.

### Message Management:

The message generation unit (37) receives information from the Optimization (10), State detection (34), and Regulation units (35) and generates the messages (29) sent to other systems. It shall keep track of messages sent and which messages have been acknowledged or approved. The message generation unit shall also invalidate messages if they no longer apply.

### The OO System Generates Eight Types of Messages:

### Control Signals:

The control signals (23) are sent to equipment that is controlled by the server (20). They are set points that are sent to the DAQ (37), which determines where the control lies at each instance (automatic control may have been overridden by the user in some way), and, if applicable, forwards the OO control signals to the PLCs that control the corresponding equipment.

### Advice

Advice messages (38) are sent to the client computer where they are displayed. An advice message (38) contains the following information:

Short text message that describes a specific operation that should be performed.

An estimate of the amount of fuel saved by performing the operation.

If the operation described in the advice can be performed from the system (through a controlled object), a confirmative action is attached to the operation. If the operation is confirmed by the user it is performed by the system.

### Warnings:

Warnings (39) are short text messages generated if the system detects that it cannot control the vessel within the specified constraints. If the system is for example configured to control propeller thrust with the aim of minimizing oil usage pr. mile with the constraint that the vessel should arrive at its destination before some specified time, the system should generate a warning if it detects that the destination cannot be reached within the time constraint.

### Conditional Alerts:

The conditional alert (40) messages contain the message string associated with the condition.

### Numerical Results:

A numerical results (41) message is sent for each variable that is displayed in the HMI. The message contains the following information: Measured value used in the simulation (if available), Optimal value, and Deviation between optimal and measured values (if the measurement is available)

Numerical result messages should be sent when significant changes to the state of equipment occur.

### State:

The OO shall detect the operation being performed onboard and send a message that identifies the current state (42).

### Time in State (43):

The OO measures the time spent in the current state and sends a message. The time spent in a group of states can also be measured.

### Achievable Savings:

An achievable savings (44) message contains an estimate of possible energy savings in each subsystem (propulsion, refrigeration or fishing gear) and an estimate of the total achievable savings.

All messages include a time stamp, i.e. the time they were sent from the OO service. ‘Pending’ advice messages (38), conditional alerts (40) and warnings are displayed on the client computer, and all such messages are available in the Messages History, regardless of their status, Numerical results (41) and control signals (23) are displayed on the client computer. The time constraints that apply to the delivery of control messages can differ. Sometimes it is sufficient to generate messages in a fixed time interval, for example every two seconds, and sometimes it may be necessary to respond immediately to user input by generating messages, for example when controlling propeller pitch and main engine rotation. There the thrust is set by the user and the system must respond immediately by sending control signals for pitch and rotation that will achieve the specified thrust. The signals do not have to be optimal if the thrust is being modified frequently, for example when the vessel is accelerating, but if the ship is cruising at constant thrust the control should be optimized.

The OO system is equally adaptable to different types of vessels for example fishing ships and cargo vessels. It should not be necessary to modify and rebuild the OO (33) service for each installation. All configurations such as variable definitions, optimization problem descriptions and type of optimization algorithm to use are defined externally and the system configured automatically when it is started.

### Report Generation:

The Report Generator has the role of extracting information from the database (14), processing it and presenting it to the user in the form of a report. The report presented to the end user is based on his/hers request parameters and navigation through the Report Viewer UI-component.

Report options and content will vary between different application areas. There will for example be a difference in the reports presented for fishing vessels and cargo carriers. The Report Generator must contain the following features:

### Data Handling

Configurability for using different data storages. Connectivity to a data storage associated with the DAQ (37). Fetching of data from data storage and user request parameters.

### Report Creation

Capability of displaying reports that the user can view and browse between. Capability of rendering reports for HTML, PDF, Excel. Capability of scheduling and emailing reports for report subscription.

### Report Reusability

Reports should be reusable between similar application areas, i.e. fishing vessels in similar fishing operation.

### Data Quality

The data required for creating reports depends on the application area, customer needs and data available from the DAQ and the Trip Summary.

1-40. (canceled)

41. A method for creating computer simulation model of a ship, optimized for fuel efficiency, said method comprising the steps of:
creating a computer simulation model of said ship, based on predetermined constraints;
optimize said computer simulation model, to obtain an optimized objective function;
simulate said computer simulation model;
analyze said optimized objective function;
wherein creating said computer simulation model involves selecting:
at least one equation from a pool of equations, the pool comprising:
hull core equations;
propulsion system core equations; and
machinery and structural core equations; and
data from a pool of data describing characteristics of ship's core components and structures, and
wherein simulating said computer simulation model involves:
applying values from said pool of data describing components characteristics to said pool of equations to optimize said fuel efficiency of said ship, and
wherein analyzing said optimized objective function involves comparing design parameters of said optimized computer simulation model to said predetermined constraints
CHARACTERIZED IN THAT said pool of data describing components' characteristics are described as model components in said computer simulation model, said model components are cascaded together.

42. A method according to claim 41 wherein creating said computer simulation model involves selecting:
at least two equations from a pool of equations, the pool comprising:
hull core equations, wherein the hull is modeled as a component;
propulsion system core equations, wherein the propulsion system is modeled as a component; and
machinery and structural core equations, wherein the machinery and structural items are modeled each as a component.

43. A method according to claim 41 wherein the hull core equations comprise one or more equations selected from a group of equations comprising:
block coefficient;
water plane coefficient;
mid-ship section coefficient;
longitudinal prismatic coefficient;
frictional resistance;
longitudinal center of buoyancy;
appendage resistance;
wave resistance;
eddy resistance;
bow pressure resistance;
air resistance;
wake velocity;
propeller resistance.

44. A method according to claim 41 wherein the propeller core equations comprise one or more equations selected from a group of equations comprising:
expandable blade area ratio;
propeller efficiency;
thrust coefficient;
torque coefficient.

45. A method according to claim 41 wherein other machinery and structural core equations comprise one or more equations selected from a group of equations comprising:
combustion process;
total efficiency;
mean pressure;
specific fuel consumption;
combustion air excess ratio;
heat loss through cooling water heat exchanger;
heat loss through lubricating oil heat exchanger;
heat transfer to ambient;
pressure losses inside heat transfer tubes;
pool boiling process;
convective boiling process;
nucleate boiling process;
heat transfer coefficients;
flux outside the evaporator tubes;
Reynolds number;
condensing temperature;
Prandtl number;
Nusselts number.

46. The method according to claim 41, wherein simulating said computer simulation model comprises the steps of:
a) initialize control parameters;
simulate said computer simulation by performing the following steps until either an optimal solution is obtained or maximum number of tries have been exceeded:
b) generate a new test set;
c) temporarily replace old test set with said new test set;
d) count constraints variables;
e) solve said model and calculate objective function;
f) optimize objective function;
if an optimal solution is not reached execute the additional steps:
g) calculate constraint violations;
h) calculate optimal value;
and start over from step-b)
i) store optimized objective function;
j) check if number of iterations are within limit;
wherein the resulting optimized and simulated objective function represents an optimal design of said ship according to predetermined requirements and constraints;
wherein multiple constraints variables can be selected at same time for each simulation.

47. A method according to claim 46 wherein said constraints variable comprise one or more of the following constraints:
maximum/minimum number of main engines, and specification;
maximum/minimum number of auxiliary engines, and specification;
maximum/minimum number of propellers, type, and specification;
maximum/minimum propeller diameter;
maximum/minimum overall length of hull, and design;
maximum/minimum number of refrigeration units, type, and specification;
maximum/minimum volume of displacement.

48. A method according to claim 41 wherein the optimizing function is cost driven.

49. A method according to claim 48 wherein the optimizing function minimizes the cost of building a ship.

50. A method according to claim 48 wherein the optimizing function minimizes the operational cost of a ship.

51. A method according to claim 48 wherein the optimizing function maximizes the net present value of a ship.

52. A computer program or suite of computer programs so arranged such that when executed on a processor said program of suite of programs cause(s) said processor to perform the method of claim 41.

53. A computer readable data storage medium storing the computer program or at least one of the suite of computer programs of claim 52.

54. A computer program product according to claim 52, wherein a database resides on the same computer as said computing program product.

55. A computer program product according to claim 52, wherein a database, and said computing program product reside on different computers.

56. A system for creating an optimized computer simulation model of a ship, said system comprising:
a human machine interface;
a computing means;
a computer program product according to claim 52;
a database;
wherein an operator creates a computer simulation model of said ship:
by communicating design parameters to said human machine interface; and
optimize said computer simulation model by instructing said computing means to execute said simulation and optimization methods encoded in said computer program product,
wherein said computing means communicates the resulting model to the operator via the human machine interface, and optionally stores said results in memory.

57. A system according to claim 56, wherein the database resides on the same computer as the computer program product.

58. A system according to claim 56, wherein the database and the computer program product reside on different computers.

59. A method for optimizing the building process of a ship for fuel efficiency by use of the system of claim 56.

60. A method for optimizing fuel efficiency of a ship, said method comprising the steps of:
storing a computer simulation model of said ship, said model optimized for fuel efficiency;
receiving at least one signal from one or more sensors;
generating one or more optimized parameters from said computer generated simulation model in dependence on said signals;
outputting said parameters,
CHARACTERIZED IN THAT in said computer simulation model said ship's core components and structures are described as model components with defined characteristics from a pool of data describing components' characteristics, said model components are cascaded together, and said optimized parameters are input parameters of the various components, wherein said optimized parameters are based on simulation of the energy system of the ship as modeled.

61. A method according to claim 60, wherein said sensor signal is received from a network of sensors for monitoring said ship, said network being arranged to monitor one or more of:
engine parameters;
structural parameters;
external parameters; and
other parameters.

62. A method according to claim 61, wherein engine parameters comprise one or more parameters selected from a group of parameters comprising:
exhaust gas temperature;
charge air pressure;
charge air temperature;
engine speed (RPM);
cooling water temperature;
lubricating oil temperature;
lubricating oil pressure;
fuel oil temperature;
fuel oil pressure;
fuel consumption.

63. A method according to claim 61, wherein structural parameters comprise one or more parameters selected from a group of parameters comprising:
levels in fuel oil tanks;
levels in water tanks;
levels in ballast tanks;
hold temperature;
actual speed.

64. A method according to claim 61, wherein external parameters comprise one or more parameters selected from a group of parameters comprising:
weather conditions;
location;
actual speed;
time;
ocean currents
weather forecast.

65. A method according to claim 61, wherein other parameters comprise one or more parameters selected from a group of parameters comprising:
electrical power output;
propeller power output;
refrigeration needs;
refrigeration resources;
auxiliary power resources;
speed of ship over surface.

66. A method according to claim 60, wherein said output is communicated to an operator via human machine interface.

67. A method according to claim 60, wherein said output parameters are communicated to a controller which controls the ship systems.

68. A method according to claim 67, wherein said controller controls said ship systems in dependence on said output parameters.

69. A computer program or suite of computer programs so arranged such that when executed on a processor said program of suite of programs cause(s) said processor to perform the method of claim 60.

70. A computer readable data storage medium storing the computer program or at least one of the suite of computer programs of claim 69.

71. A system for optimizing fuel efficiency of a ship, said system comprising:
a processor;
data storage storing a computer simulation model relating to a ship, said model optimizing fuel efficiency; and
a network of sensors for monitoring said ship;
wherein said processor is arranged in use to generate one or more optimized parameters from said computer simulation model in dependence on said one or more received signals from said network of sensors, and to output said optimized parameters.

72. A system according to claim 71, wherein said network of sensors for monitoring said ship comprises one or more of:
a sensor or group of sensors for monitoring engine parameters;
a sensor or group of sensors for monitoring structural parameters;
a sensor or group of sensors for monitoring external parameters
a sensor or group of sensors for monitoring other parameters.

73. A system according to claim 71, wherein the sensor or sensors for monitoring engine parameters comprise one or more sensors selected from a group of sensors comprising:
exhaust gas temperature sensor;
charge air pressure sensor;
charge air temperature sensor;
engine speed (RPM) sensor;
cooling water temperature sensor;
lubricating oil temperature sensor;
lubricating oil pressure sensor;
fuel oil temperature sensor;
fuel oil pressure sensor;
fuel consumption sensor.

74. A system according to claim 71, wherein the sensor or sensors for monitoring structural parameters comprise one or more sensors selected from a group of sensors comprising:
sensor for monitoring levels in fuel oil tanks;
sensor for monitoring levels in water tanks;
sensor for monitoring levels in ballast tanks;
sensor for monitoring hold temperature;
sensor for monitoring actual speed.

75. A system according to claim 71, wherein the sensor or sensors for monitoring external parameters comprise one or more sensors selected from a group of sensors comprising:
sensor for monitoring weather conditions;
sensor for monitoring location;
sensor for monitoring actual speed;
a timer or chronometer;
sensor for monitoring ocean currents
weather forecast receiver.

76. A system according to claim 71, wherein sensors for monitoring other parameters comprise one or more sensors selected from a group of sensors comprising:
electrical power output sensor;
propeller power output sensor;
sensor for monitoring refrigeration needs;
sensor for monitoring refrigeration resources;
sensor for monitoring auxiliary power resources;
sensor for monitoring speed of ship over surface.

77. A system according to claim 71, wherein said processor communicates output parameters to an operator via human machine interface.

78. A system according to claim 71, wherein the system further comprises a controller for controlling the ship systems whereby to permit improvement of the fuel usage of said ship.

79. A system according to claim 78, wherein said controller receives said optimized parameters from said processor, and controls said ship systems in dependence on said optimized parameters.

80. A method according to claim 60, wherein said computer simulation model optimized based on historical data.
